(19) United States
(12) Patent Application Publication
(10) Pub. No.: US 2009/0287606 A1
(43) Pub. Date: Nov. 19, 2009

(54) SYSTEM AND TERMINAL DEVICE FOR ELECTRONIC MONEY TRANSACTION ON INFORMATION AND METHOD THEREOF

(75) Inventors: Yutaka TAKAMI, Yokohama-shi (JP); Shigeyuki ITOH, Zushi-shi (JP); Kenji MATSUMOTO, Yokohama-shi (JP); Masayuki INOUE, Fujisawa-shi (JP); Koichi YONETA, Yokohama-shi (JP); Tetsuharu INAMITSU, Chigasaki-shi (JP)

Correspondence Address: MATTINGLY & MALUR, P.C., 1800 DIAGONAL ROAD, SUITE 370, ALEXANDRIA, VA, 22314, US

(73) Assignees: HITACHI, LTD., Tokyo (JP); HITACHI VIDEO AND INFORMATION SYSTEM, INC., Kanagawa-ken (JP)

(21) Appl. No.: 12/508,359

(22) Filed: Jul. 23, 2009

Related U.S. Application Data
(63) Continuation of application No. 09/201,867, filed on Nov. 30, 1998, now abandoned.

(30) Foreign Application Priority Data
Dec. 9, 1997 (JP) 09-338940

(51) Int. Cl. G06Q 40/00

(52) U.S. Cl. 705/41; 235/379

(57) ABSTRACT

An electronic money transferring method that enables the payment of electronic money through an electronic money transferring system with reliability. An external information processor is operated to enter the product number of a desired product, and then a host apparatus sends information about electronic money information indicating an amount of money necessary for purchasing the product, etc. to a control unit. The data processing unit reads electronic money information indicating the amount of money from an IC card. The electronic money information is transferred to the host apparatus.

### CROSS-REFERENCES TO RELATED APPLICATIONS

This application is a continuation of pending U.S. patent application Ser. No. 09/201,867, filed Nov. 30, 1998, which is hereby incorporated by reference, and which relates to and claims priority from Japanese Patent Application No. JP 09-338940, filed on Dec. 12, 1997.

### BACKGROUND OF THE INVENTION

The present invention relates to an electronic money transaction system using an electronic purse system for exchanging electronic money information stored in IC cards instead of actual money and, more particularly, to an electronic money transaction system suitable for exchanging electronic money information specified by information processing units, a terminal device for the electronic money transaction system, and an electronic money transacting method to be carried out by the same.

A prior art electronic money transaction system using an electronic purse system for exchanging electronic money information disclosed in, for example, Japanese Patent Laid-open No. 3-92966 transacts exchanging electronic money by inserting an IC card into a special device, such as a POS terminal. The electronic money information transaction system uses the excellently reliable special device to secure the reliability of the transaction of electronic money information.

However, when the exchange of electronic money information can be achieved only through such a special device, a person possessing an IC card must go to a place where such a special device is installed, such as an authorized shop, and the IC card must be inserted into the special device to carry out a transaction when the person expects some service. Therefore, the prior art electronic purse system could not be a suitable means for effectively utilizing the convenience of electronic money information exchange.

Accordingly, it is an object of the present invention to solve such a problem and to provide an electronic money transaction system facilitating the exchange of electronic money information by means of a private terminal device and capable of securing the reliability of transactions using electronic money information, a terminal device to be employed in the electronic money transaction system, and an electronic money transacting method to be carried out by the electronic money transaction system.

### SUMMARY OF THE INVENTION

With the foregoing object in view, the present invention makes an operation to insert an IC card directly into a device that provides service unnecessary by incorporating a data communication means connected to a public data network into a terminal device possessed by a person (hereinafter referred to as “private terminal device”) to transfer electronic money information through the data communication means.

The present invention enables the accomplishment of an electronic money information transfer procedure once the same has been started even if hardware malfunctions by enabling members necessary for transferring electronic money information to operate.

### BRIEF DESCRIPTION OF THE DRAWINGS

FIG. 1 is a block diagram of a private terminal device in a system and a terminal device for electronic money transaction on information and a method thereof in a first embodiment according to the present invention;

FIG. 2 is a block diagram of the electronic money transaction system of the present invention;

FIG. 3 is a flow chart of an information processing procedure to be carried out by an external information processor shown in FIG. 1;

FIG. 4 is a flow chart of a control procedure to be carried out by a control unit shown in FIG. 1;

FIG. 5 is a block diagram of a private terminal device in a system and a terminal device for electronic money transaction on information and a method thereof in a second embodiment according to the present invention;

FIG. 6 is a flow chart of an information processing procedure to be carried out by an external information processor shown in FIG. 5;

FIG. 7 is a flow chart of a control procedure to be carried out by a control unit shown in FIG. 5;

FIG. 8 is a block diagram of a private terminal device included in a system and a terminal device for electronic money transaction on information and a method thereof in a third embodiment according to the present invention;

FIG. 9 is a block diagram of a private terminal device included in a system and a terminal device for electronic money transaction on information and a method thereof in a fourth embodiment according to the present invention;

FIG. 10 is a block diagram of a private terminal device included in a system and a terminal device for electronic money transaction on information and a method thereof in a fifth embodiment according to the present invention;

FIG. 11 is a block diagram of a private terminal device included in a system and a terminal device for electronic money transaction on information and a method thereof in a sixth embodiment according to the present invention;

FIG. 12 is a diagram of assistance in explaining the construction of an optical direction signal in FIG. 11;

FIG. 13 is a flow chart of an information processing procedure to be carried out by an external information processor shown in FIG. 11;

FIG. 14 is a flow chart of a control procedure to be carried out by a control unit shown in FIG. 11;

FIG. 15 is block diagram of a private terminal device included in a system and a terminal device for electronic money transaction on information and a method thereof in a seventh embodiment according to the present invention;

FIGS. 16(a), 16(b) and 16(c) are diagrams of assistance in explaining the construction of optical information signal in FIG. 11;

FIG. 17 is a diagram of assistance in explaining the construction of electronic money information in FIG. 11;

FIG. 18 is a flow chart of an information processing procedure to be carried out by an external information processor shown in FIG. 15;

FIG. 19 is a flow chart of a former half of a control procedure to be carried out by a control unit shown in FIG. 11; and

FIG. 20 is a flow chart of a latter half of the control procedure to be carried out by the control unit shown in FIG. 11.

### DESCRIPTION OF THE PREFERRED EMBODIMENTS

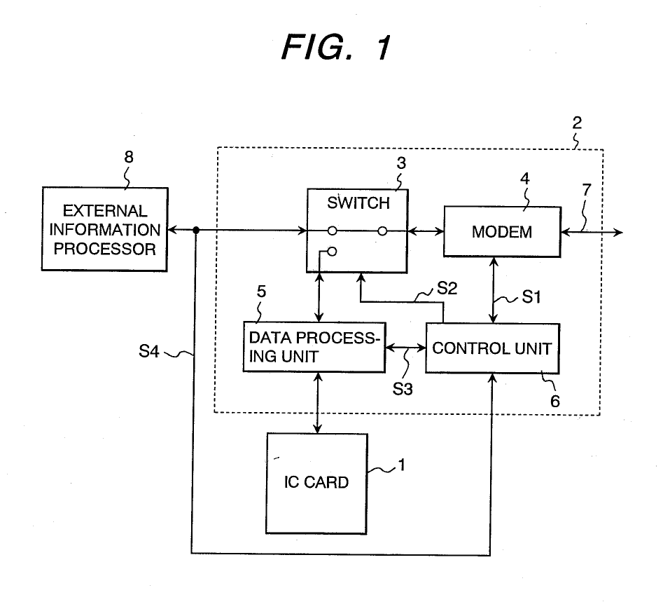

Preferred embodiments of the present invention will be described with reference to the accompanying drawings. First, an embodiment shown in FIG. 1 will be described.

Referring to FIG. 1 showing a private terminal device included in an electronic money information transaction system in a first embodiment according to the present invention in a block diagram, there are shown an IC card 1, a terminal unit 2, a switch 3, a MODEM 4, a data processing unit 5, a control unit 6, a communication line 7, and an external information processor 8.

As shown in FIG. 1, the private terminal device comprises the terminal unit 2 capable of receiving and ejecting the IC card 1 and connected to the communication line 7, such as a line of a public data network, and the external information processor 8 connected to the terminal unit 2. Electronic money information is written into the IC card 1. When the IC card 1 is inserted in the terminal unit 2, electronic money information can be written to and read from the IC card 1.

The terminal unit 2 comprises the switch 3, the MODEM 4, the data processing unit 5 and the control unit 6. The MODEM 4 is capable of receiving and sending out electronic information through the communication line 7. The switch 3 is controlled by a selecting signal S2 provided by the control unit 6.

When the switch 3 is thrown to a position to select the data processing unit 5, electronic money information is exchanged between the IC card 1 and a host apparatus, which will be described later, to write electronic money information into and to read electronic money information from the IC card 1. When writing electronic money information into the IC card 1, a signal indicating the electronic money information and a control signal are received through the communication line 7, the signals are demodulated by the MODEM 4, demodulated signals are transferred through the switch 3 to the data processing unit 5, and the demodulated signals are subjected to a predetermined process. Thus processed signal indicating the electronic money information and the control signal are given to the IC card 1. The control signal controls a write operation to write the electronic money information into the IC memory of IC card 1. When reading electronic money information from the IC card 1, a control signal is given through the communication line 7 taking the same passage to the IC card 1 to control a read operation to read the electronic money information from the IC card 1. The electronic money information read from the IC card 1 is processed by the data processing unit 5, the processed electronic money information is modulated by the MODEM 4, the modulated electronic money information is transmitted by the communication line 7.

When the switch 3 is thrown to a position to select the external information processor 8, the external information processor 8 comprising an input device, such as a keyboard, and a display is connected through the switch 3 to the MODEM 4. The external information processor 8 exchanges data and control signals through the communication line 7 with the host apparatus, not shown.

The control unit 6 exchanges control signals S4 with the external information processor 8. The control unit 6 controls the MODEM 4, the switch 3 and the data processing unit 5 according to the control signals S4. Thus, the host apparatus and the external information processor 8 are able to communicate with each other, and the IC card 1 and the host apparatus are able to exchange electronic money information.

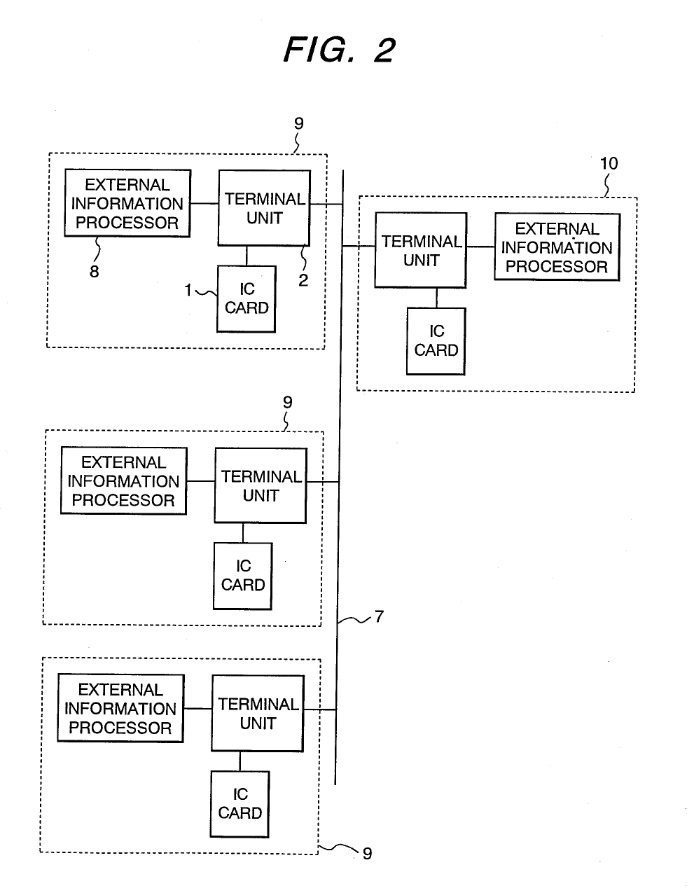

FIG. 2 is a block diagram of the electronic money information transaction system in the first embodiment including private terminal devices 9 similar to the private terminal device shown in FIG. 1. There are shown in FIG. 2 the private terminal devices 9 and the host apparatus 10, in which parts corresponding to those shown in FIG. 1 are designated by the same reference characters.

Referring to FIG. 2, the private terminal devices 9 each comprising the terminal unit 2 capable of receiving and ejecting the IC card 1 and the external information processor 8 are interconnected by a plurality of communication lines 7. The host apparatus 10 similar in configuration to the private terminal devices 9 is connected to the communication lines 7. The host apparatus 10 and each of the private terminal devices 9 are able to exchange various data, control signals and electronic money information.

The operation of the first embodiment will be described hereinafter.

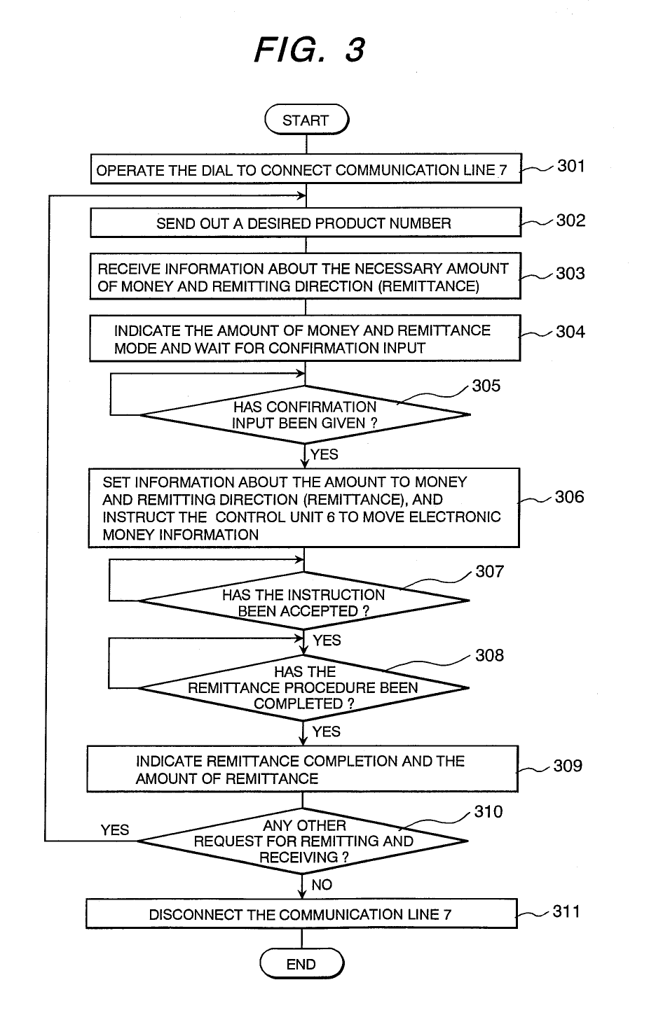

FIG. 3 is a flowchart of an information processing procedure to be carried out by the external information processor 8 shown in FIG. 1.

Referring to FIG. 3, in an initial state, the switch 3 is thrown to a position to select the external information processor 8, and the MODEM 4 is disconnected from the communication line 7. In the initial state, the external information processor 8 calls the host apparatus 10 by a dialing operation or the like. then, the external information processor 8 gives a control signal S4 to the control unit 6, the control unit 6 generates a control signal S1 in response to the control signal S4 to control the MODEM 4 to connect to the communication line 7. The external information processor 8 sends a call signal through the switch 3 to the MODEM 4 subsequent to the application of the control signal S4 to the control unit 6. The call signal is sent through the communication line 7 to the host apparatus 10. The host apparatus 10 provides a response to the call signal, and then the external information processor 8 is able to communicate with the host apparatus 10 (step 301).

Subsequently, the input device of the external information processor 8 is operated to enter a product number indicating an article to be purchased. Then, an information signal indicating the product number is transmitted through the switch 3, the MODEM 4 and the communication line 7 to the host apparatus 10 (step 302). The host apparatus 10 sends money information indicating a necessary amount of money and remittance data on the product identified by the product number given thereto to the terminal unit 2 through the communication line 7. The money information and the remittance data are transferred through the MODEM 4 and the switch 3 to the external information processor 8 (step 303). The external information processor 8 processes the money information and the remittance data and displays information obtained by processing the processed money information and the remittance data on the display, and requests the user to confirm whether the information displayed on the display is correct or not (step 304).

Upon execution of an operation to confirm the information (step 305) by the user, the external information processor 8 gives a control signal S4 directing electronic money information transfer on the basis of the information on amount of money and the remittance data received from the host apparatus 10 to the control unit 6 (step 306). Upon the confirmation of the reception of the control signal S4 by the control unit 6 (step 307), the external information processor 8 waits for an electronic money information transfer procedure to be completed.

That is, upon the reception of the control signal S4, the control unit 6 actuates the MODEM 4 by a control signal S1, throws the switch 3 to a position for selecting the data processing unit 5 by a control signal S2, actuates the data processing unit 5 by a control signal S3, gives a response signal indicating the reception of the control signal S4 to the external information processor 8, and sends data indicating the completion of such preparatory operations to the data processing unit 5.

Upon the reception of the data from the control unit 6, the data processing unit 5 sends data indicating the completion of preparation to the host apparatus 10 through the switch 3, the MODEM 4 and the communication line 7. Then, the host apparatus 10 sends data indicating an amount of money for remittance to be subtracted from information stored in the IC card, and a control signal through the communication line 7, the MODEM 4 and the switch 3 to the data processing unit 5. Data processed by the data processing unit 5 and a control signal is given to the IC card. The IC card 1 is controlled by the control signal, electronic money information corresponding to an amount of money indicated by the data is read from the IC card 1, and the data processing unit 5 processes the electronic money information and sends the processed electronic money information through the switch 3, the MODEM 4 and the communication line 7 to the host apparatus 10.

Upon the completion of remittance, the data processing unit 5 gives a remittance completion signal to the control unit 6 and sends a control signal S4 indicating the completion of remittance through the control unit 6 to the external information processor 8. The control unit 6 throws the switch 3 to the position for selecting the external information processor 8.

Upon the reception of the control signal S4 indicating the completion of remittance (step 308), the external information processor 8 sends data indicating the completion of remittance through the switch 3, the MODEM 4 and the communication line 7 to the host apparatus 10, and then the host apparatus 10 sends a remittance confirmation signal through the communication line 7, the MODEM 4 and the switch 3 to the external information processor 8. The external information processor 8 displays the amount of money remitted from the IC card 1 to the host apparatus 10 (step 309).

If there are any other products to be purchased, a product number indicating the product is entered by operating the input device of the external information processor 8. Then, steps 303 to 309 are repeated for the product. If there is no other product to be purchased, the information processing procedure is ended by operating the input device of the external information processor 8 (step 310) to give a control signal S4 indicating the end of the information processing procedure to the control unit 6. Then, the control unit 6 generates a control signal S1 to disconnect the terminal unit 2 from the communication line 7 by controlling the MODEM 4 (step 311). In this state, the switch 3 is controlled so as to select the external information processor 8 to set the private terminal devices 9 in the initial state.

If the purchase of a plurality of products is desired, the product numbers of all the products can be entered in step 302 at once. If the product numbers of the plurality of products are entered, steps 303 to 308 are executed for each of the product number. After the remittance for all the product numbers has been completed (step 308), information indicating the completion of remittance and the individual amounts of money are displayed (step 309). Then, the user executes the information processing procedure ending operation to disconnect the terminal unit 2 from the communication line 7 (step 311).

The first embodiment is thus carried out the information processing procedure for transferring electronic money information connected with the purchase of products.

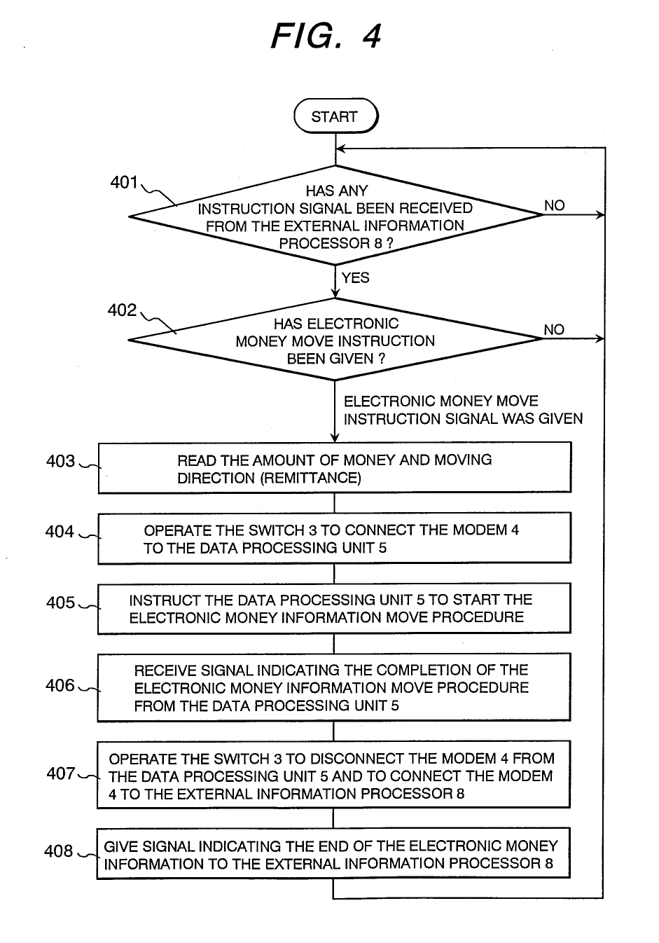

FIG. 4 is a flowchart of a control procedure to be carried out by the control unit 6 of the terminal unit 2 shown in FIG. 1.

Referring to FIG. 4, first of all, the switch 3 is thrown to the position to connect the MODEM 4 to the external information processor 8. The external information processor 8 communicates through the communication line 7 with the host apparatus 10, determines basic information including the amount of money and the direction of its movement (remitting direction) and the like about electronic money information, and gives a control signal S4 instructing the control unit 6 to start transferring the electronic money information in addition to the information indicating the amount of money and the remitting direction.

Upon the reception of the control signal S4, i.e., an instruction signal for remittance (step 401), the control unit 6 reads the amount of money and the remitting direction (step 403) if the control signal S4 indicates an instruction to start transferring the electronic money information (step 402). The control unit 6 returns a control signal S4 indicating the reception of those signals to the external information processor 8, controls the switch 3 by a control signal S2 to connect the MODEM 4 to the data processing unit 5 (step 404).

After the operation of the switch 3 has been completed, the control unit 6 sends a control signal S3 indicating data requesting the transfer of the electronic money information to the data processing unit 5 (step 405). Then, the data processing unit 5 starts the transfer of the electronic money information between the IC card 1 through the switch 3, the MODEM 4 and the communication line 7, and the host apparatus 10 and processes the electronic money information to be transferred. After the transfer of the electronic money information has been completed, the data processing unit 5 sends control signal S3 indicating the completion of electronic money information transfer to the control unit 6.

Upon the reception of the control signal S3 (step 406), the control unit 6 generates a control signal S2 for throwing the switch 3 to a position for selecting the external information processor 8 to connect the external information processor 8 through the MODEM 4 to the communication line 7 (step 407), gives a control signal S4 indicating the completion of electronic money information transfer to the external information processor 8, and waits until a control signal S4 indicating the next instruction is sent thereto by the external information processor 8 (step 401).

In the first embodiment, the operations of the external information processor 8, and the control unit 6 of the terminal unit 2 enables the user expecting service for a payment by electronic money information stored in the IC card 1 to achieve the exchange of the electronic money information easily only by executing confirmation operations through the external information processor 8.

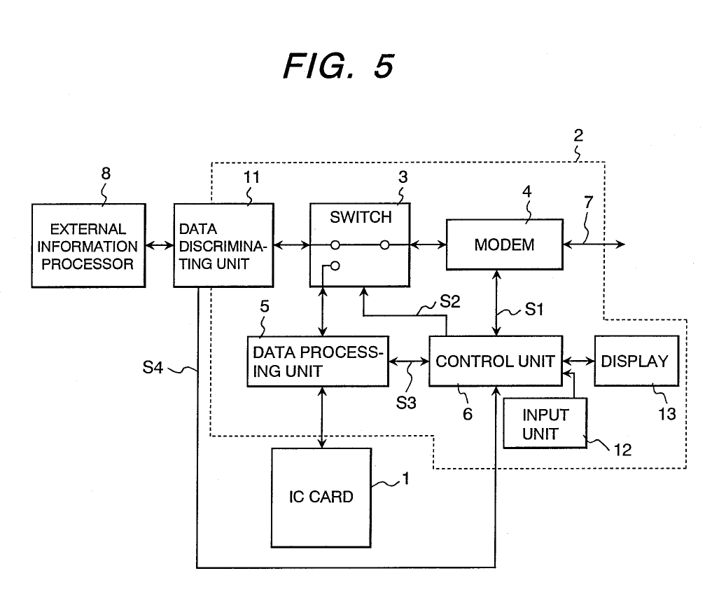

FIG. 5 is a block diagram of a private terminal device employed in a second embodiment of an electronic money information transaction system according to the present invention, in which parts like or corresponding to those shown in FIG. 1 are designated by the same reference characters and the description thereof will be omitted to avoid duplication. The constitution of the electronic money information transaction system in the second embodiment is similar to that of the electronic money information transaction system in the first embodiment shown in FIG. 2. Shown in FIG. 5 are a data discriminating device 11, an input unit 12 and a display 13.

Referring to FIG. 5, the input unit 12 and the display 13 are included in the terminal unit 2. The input unit 12 and the display 13 are connected to the control unit 6, and the external information processor 8 is connected through the data discriminating device 11 to the switch 3. The external information processor 8, differing from the external information processor 8 employed in the first embodiment, is provided with neither an input unit nor a display. The private terminal device is the same as that shown in FIG. 1 in other respects.

The data discriminating device 11 analyzes data provided by the external information processor 8 and decides whether the data is an information signal to be sent to the host apparatus 10 through the MODEM 4 and the communication line 7 or the data is a control signal S4 to be sent to the control unit 6.

The operation of the second embodiment will be described hereinafter on an assumption that the second embodiment is applied, similarly to the private terminal device shown in FIG. 1, to purchasing a product by mail-order.

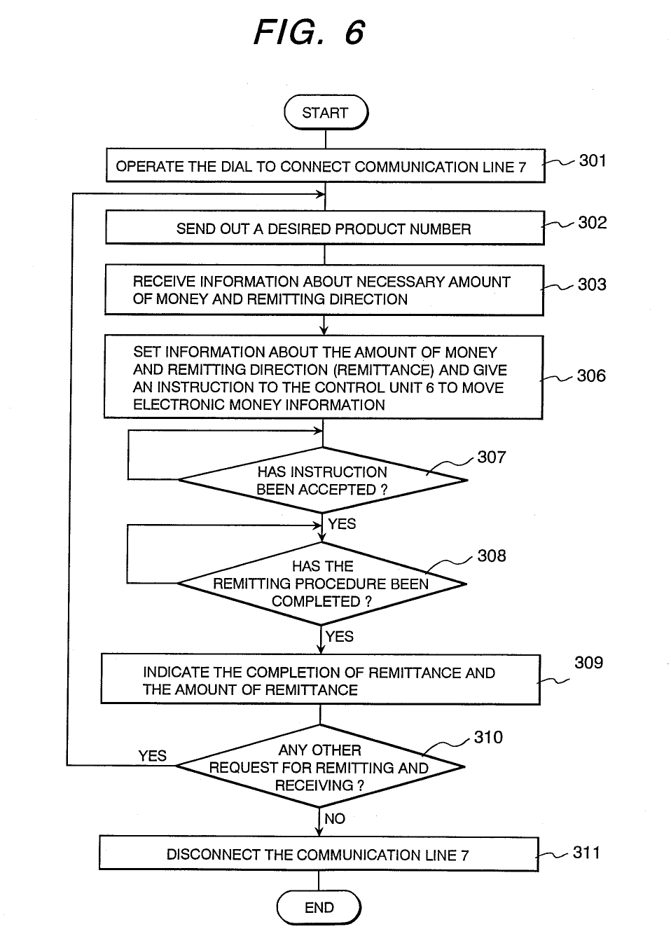

FIG. 6 is a flowchart of an information processing procedure to be carried out by the external information processor 8 included in the private terminal device shown in FIG. 5. The information processing procedure shown in FIG. 6 is substantially the same as that shown in FIG. 3 to be carried out by the external information processor 8 included in the private terminal device shown in FIG. 1, hence steps of the information processing procedure shown in FIG. 6 similar to those of the information processing procedure shown in FIG. 3 are designated by the same step number and the description thereof will be omitted to avoid duplication.

Referring to FIG. 6, upon the reception of the electronic money information indicating the amount of money and the remitting direction (step 303), the external information processor 8 gives the control unit 6 a transfer instruction without confirming the electronic money information indicating the amount of money and the remitting direction (step 306). The external information processor 8 does not execute operations corresponding to steps 304 and 305 of the information processing procedure shown in FIG. 3, and those operations are carried out by the control unit 6 because the display 13 is included in the terminal unit 2, which will be described later.

The data discriminating device 11 analyzes and identifies the control signal provided by the external information processor 8. The data discriminating device 11 transfers the control signal S4 to the control unit 6 if the control signal S4 is a transfer instruction instructing the control unit 6 to transfer the electronic money information, or to the switch 3 if the same is a control signal including data to be given to the host apparatus 10.

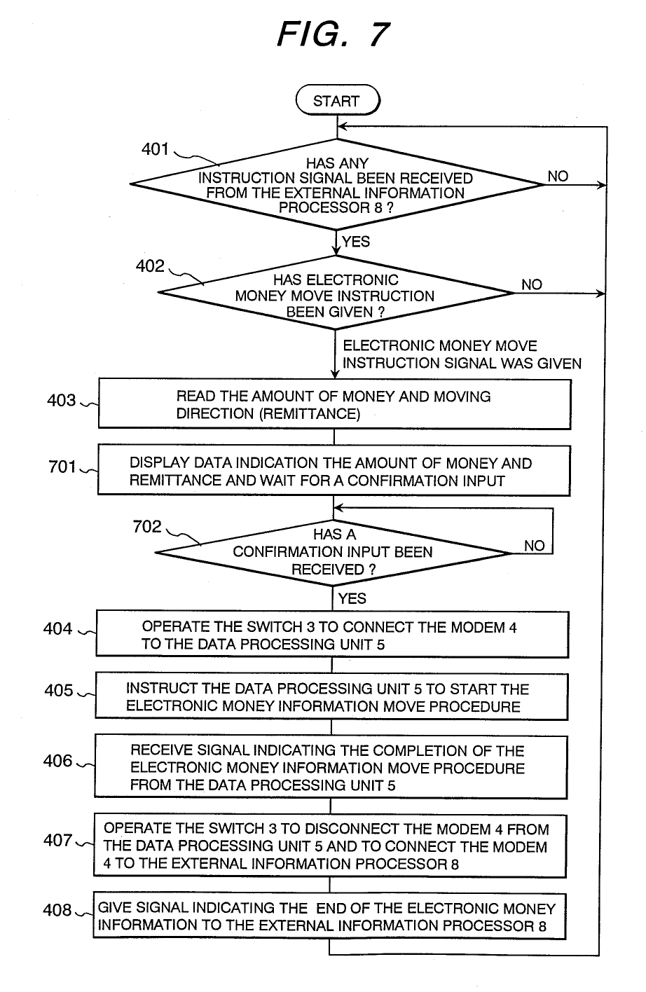

FIG. 7 is a flowchart of a information processing procedure to be carried out by the control unit 6 included in the private terminal device 2 shown in FIG. 5, in which steps corresponding to those of the information processing procedure shown in FIG. 4 are designated by the same step numbers.

The operation of the control unit 6 included in the terminal unit 2 shown in FIG. 5 is substantially the same as that shown in FIG. 4 of the control unit 6 included in the terminal unit 2 shown in FIG. 1. Since the input unit 12 and the display 13 are included in the terminal unit 2 shown in FIG. 5, and the input unit 12 and the display 13 are controlled by the control unit 6, the operation of the control unit 6 included in the terminal unit 2 shown in FIG. 5 is different from that of the control unit 6 included in the terminal unit 2 shown in FIG. 1. The information processing procedure shown in FIG. 7 has additional steps 701 and 702 inserted between steps 403 and 404. Steps 701 and 702 correspond to steps 304 and 305 of the information processing procedure shown in FIG. 3.

Referring to FIG. 7, the control unit 6 shown in FIG. 5 which is similar to the control unit 6 included in the terminal unit 2 shown in FIG. 1, reads electronic money information indicating the amount of money and remitting direction given thereto together with a transfer start command by the external information processor 8 (step 403), and displays the electronic money information on the display 13 (step 701). After the user confirms the electronic money information and operates the input unit 12 for a predetermined data confirming operation (step 702), the control unit 6 sends a control signal S4 indicating the confirmation of the electronic money information to the external information processor 8, controls the switch 3 by generating a control signal S2 to connect the MODEM 4 to the data processing unit 5 (step 404). The following operations of the control unit are the same as those of the control unit 6 included in the terminal unit 2 shown in FIG. 1 previously described with reference to FIG. 4.

Thus, in the second embodiment, the external information processor 8 deals only with obtaining basic information, such as the electronic money information indicating the amount of money and the remitting direction. The actual transfer of the electronic money information is executed after the user has entered a confirmation signal by operating the input unit 12. All the steps of the electronic money information transfer procedure from the start to the end are executed by the control unit 6. Since the external information processor 8 does not take part in the electronic money information transfer procedure at all, the second embodiment is able to achieve the electronic money information transfer procedure more safely than the first embodiment.

Since the second embodiment is provided with the data discriminating device 11, all the data and the control signals given to the MODEM 4 are control signals for controlling the operation of the MODEM 4 and data to be sent to a external devices, i.e., the communication line 7. Accordingly, the MODEM 4 need not identify the control signal S4 given by the external information processor 8 to the control unit 6, which must be identified by the first embodiment, to thereby simplify the structure of MODEM 4.

FIG. 8 is a block diagram of a private terminal device included in an electronic money information transaction system in a third embodiment according to the present invention, in which parts like or corresponding to those of the private terminal device shown in FIG. 5 are designated by the same reference characters and the description thereof will be omitted. In FIG. 8, indicated at 14 is a power circuit, at 15 is a charging circuit and at 16 is a storage battery. The constitution of the electronic money information transaction system in the third embodiment is similar to that of the electronic money information transaction system in the first embodiment shown in FIG. 2.

Referring to FIG. 8, the terminal unit 2 is provided with the power circuit 14 comprising the battery 16 and the charging circuit 15 to be connected to an external power source, not shown, to charge the storage battery 16 continuously. The configuration of the terminal unit 2 is the same in other respects as that of the terminal unit 2 of the second embodiment shown in FIG. 5. The power circuit 14 supplies a supply voltage to the switch 3, the MODEM 4, the data processing unit 5 and the control unit 6.

The operation of the third embodiment will be described.

Operations for controlling the switch 3 and operations for transferring electronic money information through the MODEM 4 and the communication line 7 controlled by control signals provided by the external information processor 8 are similar to those carried out by the second embodiment. In the third embodiment, power necessary for transferring electronic money information is supplied from the storage battery 16.

The effect of the third embodiment is the same as that of the second embodiment. Since the supply voltage is applied by the power circuit 14 externally provided to the components of the terminal unit 2 and the storage battery 16 of the power circuit 14 is charged continuously by the external power supply, the transfer operation for transferring electronic money information is not interrupted and the transfer operation for transferring electronic money information can be accomplished, for example, even if power failure occurs during the transfer operation.

The terminal unit 2 included in the third embodiment is constructed by combining the power circuit 14 to the terminal unit 2 included in the first embodiment shown in FIG. 1. The terminal unit 2 included in the second embodiment shown in FIG. 5 may be provided with a power circuit similar to the power circuit 14 for the same effect.

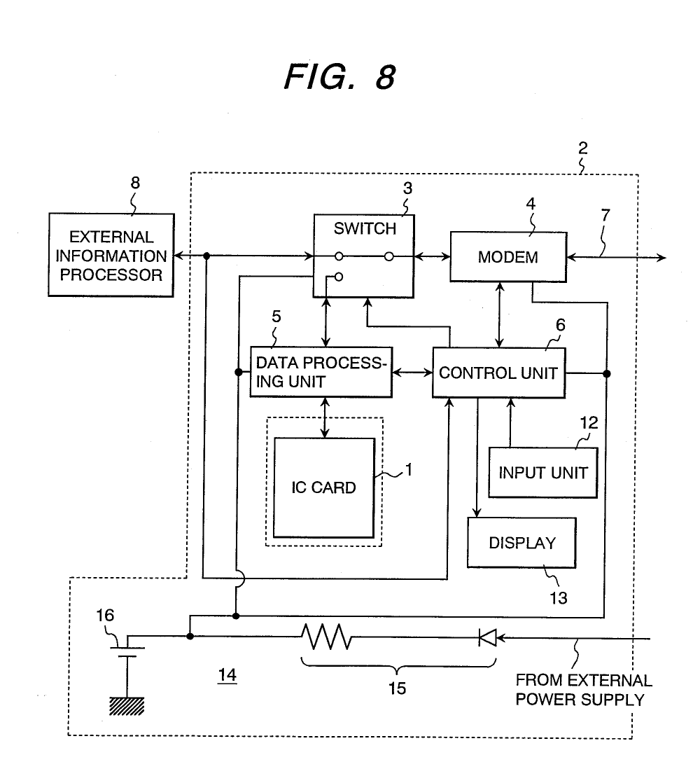

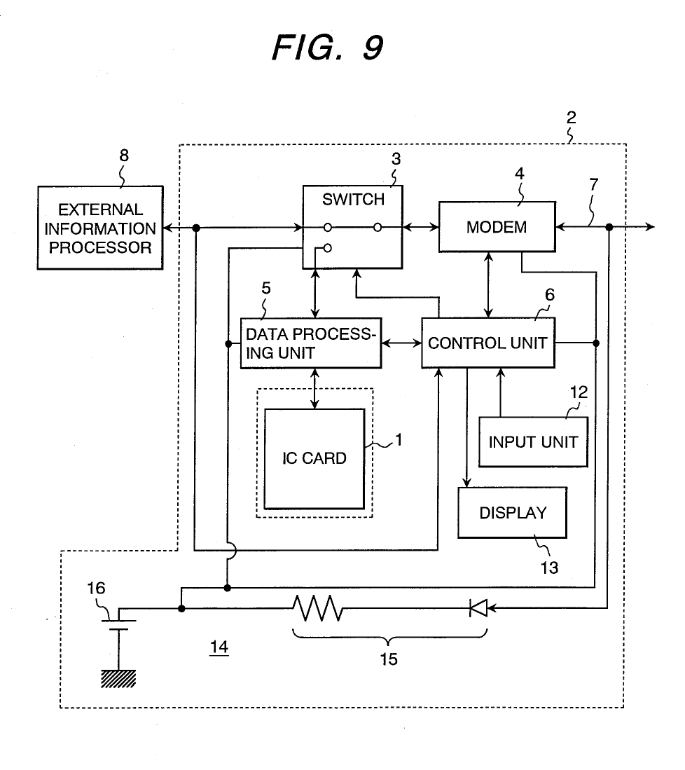

FIG. 9 is a block diagram of a private terminal device included in an electronic money information transaction system in a fourth embodiment according to the present invention, in which parts corresponding to those shown in FIG. 8 are designated by the same reference characters and the description thereof will be omitted to avoid duplication. The constitution of the electronic money information transaction system in the fourth embodiment is similar to that of the electronic money information transaction system in the first embodiment shown in FIG. 2.

Referring to FIG. 9, the charging circuit 15 is connected to the communication line 7 to charge the storage battery 16 by the charging circuit 15 while the terminal unit 2 is connected to the communication line 7.

Operations for controlling the switch 3 and operations for transferring electronic money information through the MODEM 4 and the communication line 7 controlled by control signals provided by the external information processor 8 are similar to those carried out by the second embodiment shown in FIG. 5. The fourth embodiment, similarly to the third embodiment shown in FIG. 8, uses power supplied from the storage battery 16 of the power circuit 14 for electronic money information transfer operations. In the fourth embodiment, the storage battery 16 is charged when the terminal unit 2 is connected to the communication line 7.

The fourth embodiment has, in addition to an effect similar to that of the third embodiment, an advantage that any external power source is unnecessary because the storage battery 16 can be charged by a current flowing through the communication line 7.

The terminal unit 2 included in the fourth embodiment is constructed by combining the power circuit 14 to the terminal unit 2 included in the first embodiment and shown in FIG. 1. The terminal unit 2 included in the second embodiment may be provided with a power circuit similar to the power circuit 14 for the same effect.

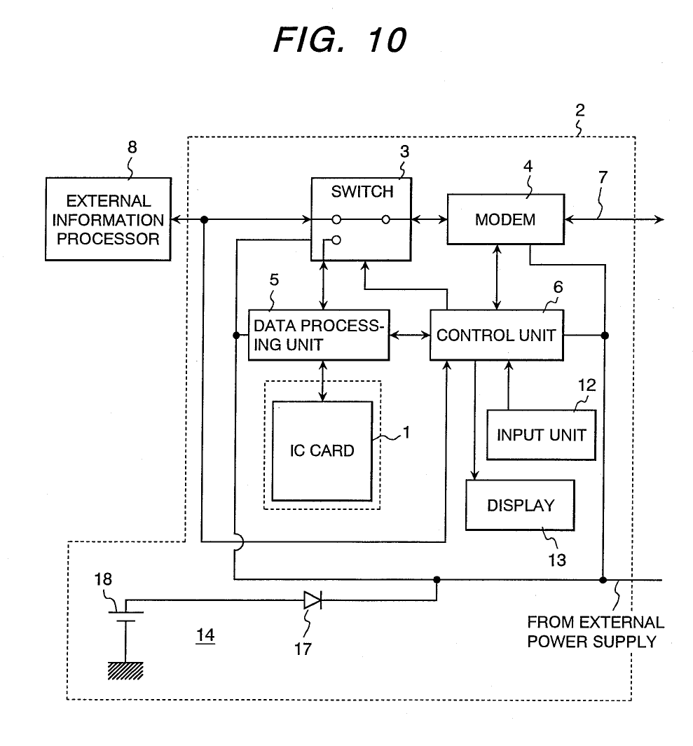

FIG. 10 is a block diagram of a private terminal device included in an electronic money information transaction system in a fifth embodiment according to the present invention, in which parts like or corresponding to those of the private terminal device shown in FIG. 8 are designated by the same reference characters and the description thereof will be omitted. In FIG. 10, indicated at 17 is a power supply selecting device and at 18 is a battery. The constitution of the electronic money information transaction system in the fifth embodiment is similar to that of the electronic money information transaction system in the first embodiment shown in FIG. 2.

Referring to FIG. 10, a supply voltage is applied to the terminal unit 2 by an external power source, not shown, and the power circuit 14 is combined with the terminal unit 2. The power circuit 14 comprises the power supply selecting device 17 and the battery 18. The power supply selecting device 17 monitors the supply voltage of the external power source continuously, and selects and electrically connects the power circuit 14 for serving as power supply to the terminal unit 2 when the supply voltage drops below a predetermined level.

Operations for controlling the switch 3 and operations for transferring electronic money information through the MODEM 4 and the communication line 7 controlled by control signals provided by the external information processor 8 are similar to those carried out by the second embodiment as shown in FIG. 5. In the fifth embodiment, power necessary for transferring electronic money information is supplied from the external power source. If power cannot be supplied to the terminal unit 2 from the external power source due to power failure or the like, the power supply selecting device 17 detects power failure or the like, connects the power circuit 14 electrically to the terminal unit 2 to apply the output voltage of the battery 18 to the components of the terminal unit 2. Accordingly, the electronic money information transfer operation is not interrupted. The battery 18 has a capacity sufficient to enable at least one cycle of the electronic money information transfer operation.

The effect of the fifth embodiment is the same as that of the second embodiment shown in FIG. 5. The supply voltage is applied to the components of the terminal unit 2 by the external power source in a normal operating state for the same effect as that of the third embodiment shown in FIG. 8. If the supply voltage of the external power source drops due to power failure or the like, the power supply selecting device 17 connects the battery 18 electrically to the terminal unit 2 to enable the accomplishment of the electronic money information transfer operation. Since the fifth embodiment employs the battery 18, any charging circuit like that employed in the third embodiment shown in FIG. 8 is unnecessary.

The terminal unit 2 included in the fifth embodiment is constructed by combining the power circuit 14 to the terminal unit 2 included in the first embodiment and shown in FIG. 1. The terminal unit 2 included in the second embodiment shown in FIG. 5 may be provided with a power circuit similar to the power circuit 14 for the same effect.

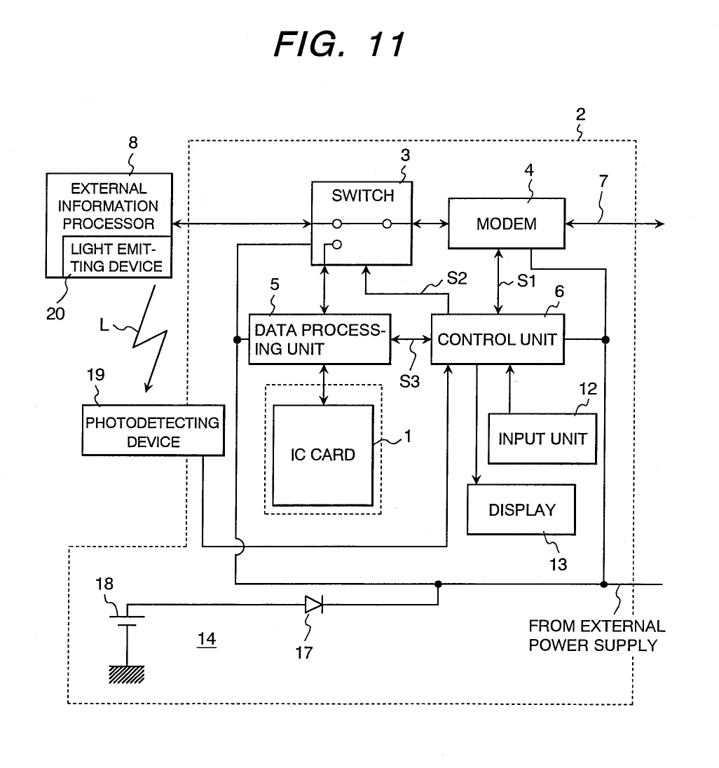

FIG. 11 is a block diagram of a private terminal device included in an electronic money information transaction system in a sixth embodiment according to the present invention, in which parts like or corresponding to those of the private terminal device shown in FIG. 10 are designated by the same reference characters and the description thereof will be omitted. In FIG. 11, indicated at 19 is a photoreceiver and at 20 is a light-emitting device. The constitution of the electronic money information transaction system in the sixth embodiment is similar to that of the electronic money information transaction system in the first embodiment shown in FIG. 2.

Referring to FIG. 11, the terminal unit 2 is provided with the photoreceiver 19, and the external information processor 8 is provided with the light-emitting device 20. Light signals are sent from the light-emitting device 20 to the photoreceiver 19. The external information processor 8 controls the light-emitting device 20 to generate a desired light instruction signal L. The photoreceiver 19 receives the light instruction signal L, converts the same into electronic data, and gives a control signal S4 indicating the electronic data to the control unit 6.

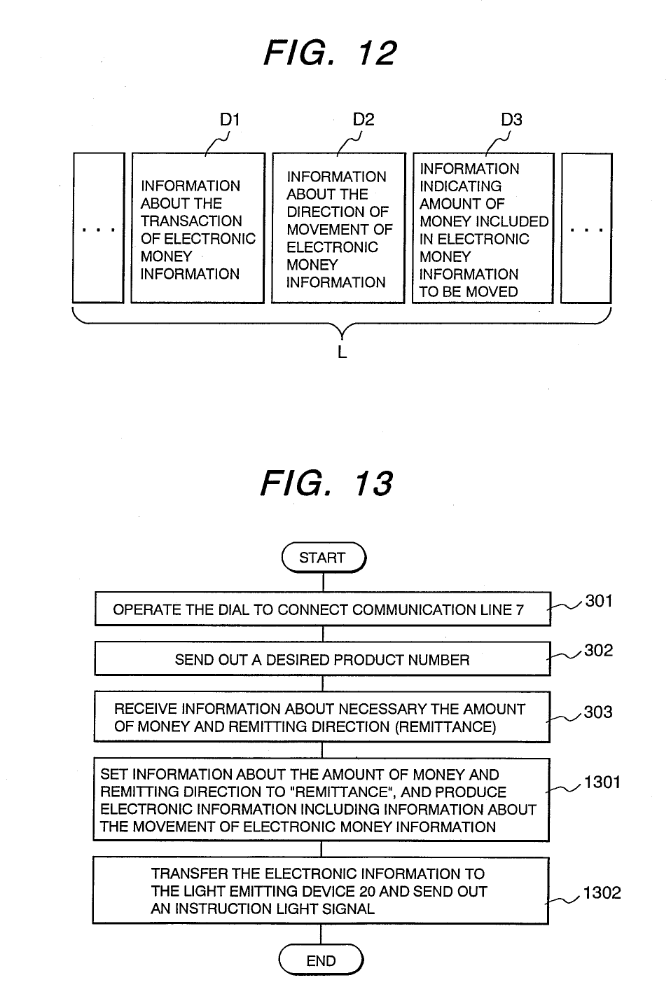

FIG. 12 shows the structure of the electronic data indicated by the light signal L.

Referring to FIG. 12, the light instruction signal L consists of information D1 showing an electronic money information transaction and directing the transfer of the electronic money information, information D2 indicating the direction of transfer of the electronic money information, and information D3 indicating the amount of money included in the electronic money information.

The operation of the sixth embodiment will be described below on an assumption that the sixth embodiment is applied, similarly to the private terminal device shown in FIG. 1, to purchasing a product by mail-order.

FIG. 13 is a flowchart of an information processing procedure to be carried out by an external information processor 8 shown in FIG. 11, in which steps corresponding to those of the information processing procedure shown in FIG. 6 are designated by the same step number.

In FIG. 13, steps 301 to 303 of communicating with the host apparatus 10 through the communication line 7 to obtain the electronic money information indicating the amount of money and the transfer direction are the same as those shown in FIG. 6 to be executed by the external information processor 8 included in the private terminal device shown in FIG. 5.

The external information processor 8 converts the information indicating the amount of money and remittance directing data sent back thereto into the information D2 indicating the direction of transfer of the electronic money information and the information D3 indicting the amount of money of the electronic money information as shown in FIG. 12 by adding information D1 which indicates the transaction information of electronic money information (step 1301). The external information processor 8 controls the light-emitting device 20 to convert and emit the information signal D1, D2 and D3 into a light instruction signal L (step 1302) and ends the information processing procedure. The photoreceiver 19 of the terminal unit 2 receives the light instruction signal L, converts the same into a corresponding electric signal, and gives a control signal S4 corresponding to the electronic signal to the control unit 6.

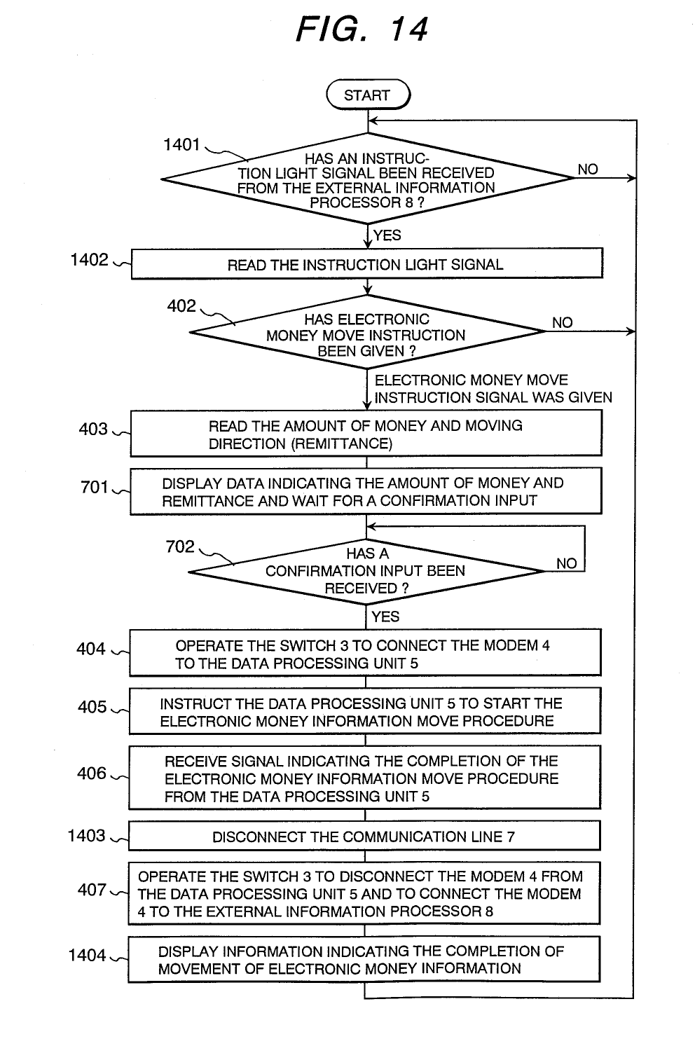

FIG. 14 is a flowchart of an information processing procedure to be carried out by the control unit 6 of the terminal unit 2 shown in FIG. 11, in which steps corresponding to those shown in FIG. 7 are designated by the same step numbers.

Referring to FIG. 14, the external information processor 8 is connected through the switch 3 and the MODEM 4 to the communication line 7, the external information processor 8 communicates with the host apparatus 10 through the communication line 7 to determine basic information indicating the amount of money and the transfer direction about the transfer of the electronic money information.

Subsequently, the external information processor 8 provides a light instruction signal L for instructing the start of transfer of the electronic money information. The photoreceiver 19 monitors light input thereto. Upon the reception of the light instruction signal L (step 1401), the photoreceiver 19 converts the light instruction signal L into a corresponding electric signal, and gives the control signal S4 to the control unit 6 (step 1402). As shown in FIG. 12, the information D1 indicating the start of transferring the electronic money information is given to the control unit 6 in addition to the amount of money and the transfer direction of the electronic money information, i.e., the information D3 and D2 shown in FIG. 12.

Upon the reception of the information D1 directing the start of transferring the electronic money information (step 402), the control unit 6 reads the information D3 indicating the amount of money and the information D2 indicating the transfer direction (step 403) and displays the information D2 and D3 on the display 13 for confirmation by the user (step 701). The user operates the input unit 12 to enter a signal indicating the confirmation of the information D2 and D3 (step 702). Then, the control unit 6 provides a control signal S2 to control the switch 3 so that the MODEM 4 is connected to the data processing unit 5 (step 404), and gives a control signal S3 indicating the transfer of the electronic money information to the data processing unit 5 (step 405). The data processing unit 5, similar to that of the foregoing embodiment, processes the electronic money information read from the IC card 1 and starts transferring the electronic money information through the switch 3, the MODEM 4 and the communication line 7 to the host apparatus 10.

After the completion of transferring the electronic money information, the data processing unit 5 sends a control signal S3 indicating the completion of transferring the electronic money information to the control unit 6. Upon the reception of the control signal S3 (step 406), the control unit 6 generates a control signal S1 for controlling the MODEM 4 to disconnect the terminal unit 2 from the communication line 7 (step 1403), and generates a control signal S2 for controlling the switch 3 to connect the MODEM 4 to the external information processor 8 (step 407). Then, the control unit 6 gives an instruction to display the transferred electronic money information indicating the amount of money and the transfer direction together with information indicating the completion of transferring the electronic money information on the display 13 (step 1404).

Thus, the terminal unit 2 employed in the sixth embodiment is able to receive the electronic money information to be transferred indicating the amount of money and the transfer direction from the external information processor 8 in a noncontact transfer mode and, therefore, any signal lines for control signal S4 which connects the control unit 6 and the external information processor 8 are not necessary.

In the sixth embodiment, the external information processor 8 operates only for obtaining basic information including the amount of money and the transfer direction and the like, and the actual electronic money information is transferred after the user has entered a confirmation signal by operating the input unit 12. Thus, all the steps of the information processing procedure for transferring the electronic money information are carried out by the control unit 6. Accordingly, the sixth embodiment is able to transfer the electronic money information more safely than the first embodiment.

Although the sixth embodiment employs the power circuit 14 employed in the fifth embodiment shown in FIG. 10, the sixth embodiment may employ the power circuit 14 shown in FIG. 8 or 9 for the same effect.

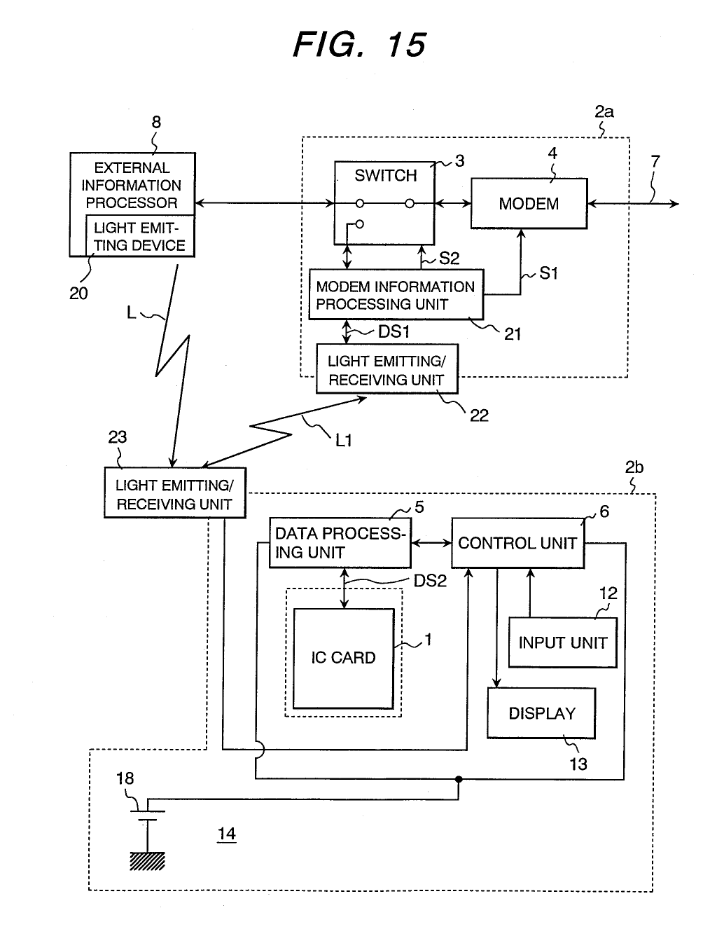

FIG. 15 is a block diagram of a private terminal device included in an electronic money information transaction system in a seventh embodiment according to the present invention, in which parts like parts like or corresponding to those of the private terminal device shown in the drawings shown previously are designated by the same reference characters and the description thereof will be omitted. In FIG. 15, indicated at 2a and 2b are first and second terminal units, at 21 is a MODEM information processing unit, and at 22 and 23 are light emitting/receiving units. The constitution of the electronic money information transaction system in the seventh embodiment is similar to that of the electronic money information transaction system in the first embodiment shown in FIG. 2.

Referring to FIG. 15, the first terminal unit 2a and the second terminal unit 2b are contained in separate cases, respectively. The first terminal unit 2a comprises the switch 3, the MODEM 4, the MODEM information processing unit 21 and the light emitting/receiving unit 22. The second terminal unit 2b comprises the data processing unit 5, the control unit 6, the input unit 12, the display 13, the power circuit 14 and the light emitting/receiving unit 23. The terminal units 2a and 2b exchange light information signal L1 by the light emitting/receiving units 22 and 23. The light emitting/receiving unit 23 of the second terminal unit 2b receives a light instruction signal L provided by the light emitting device 20 of the external information processor 8, and gives a control signal S4 to the control unit 6. The second terminal unit 2b is provided with the built-in power circuit 14 provided with a battery 18. The supply voltage of the battery 18 is applied to the data processing unit 5 and the control unit 6.

The switch 3 is controlled by a control signal S2 provided by the MODEM information processing unit 21 to select either the external information processor 8 side or the MODEM information processing unit 21 side. When the MODEM information processing unit 21 is selected by the switch 3, an information signal received through the communication line 7, the MODEM 4 and the switch 3 is processed by the MODEM information processing unit 21, the MODEM information processing unit 21 gives a corresponding signal to the light emitting/receiving unit 22, and the light emitting/receiving unit 22 converts the received signal into a corresponding light information signal L1 and gives the same to the light emitting/receiving unit 23 of the second terminal unit 2b.

The light emitting/receiving unit 22 of the first terminal unit 2a receives a light information signal L1 provided by the light emitting/receiving unit 23 of the second terminal unit 2b and converts the light information signal L1 into a corresponding electric information signal DS1. The information signal DS1 is then supplied to the MODEM information processing unit 21 for examining the contents of the information signal DS1 to see whether the information signal DS1 is a control signal, such as a control signal S1 for controlling the MODEM 4 or a control signal S2 for controlling the switch 3, or an information signal indicating electronic money information to be sent to the host apparatus 10. If the information signal DS1 received from the light emitting/receiving unit 22 is the control signal S1 for controlling the MODEM 4 or the control signal S2 for controlling the switch 3, the MODEM 4 or the switch 3 is controlled. If the signal DS1 is the information signal indicating the electronic money information, the information signal DS1 is sent through the switch 3, the MODEM 4 and the communication line 7 to the host apparatus 10.

The light emitting/receiving unit 23 has a photoreceiver for receiving the light instruction signal L of the structure shown in FIG. 12 from the light emitting device 20 of the external information processor 8. The photoreceiver receives the light instruction signal L, converts the same into a corresponding electric signal serving as a control signal S4 and gives the control signal S4 to the control unit 6.

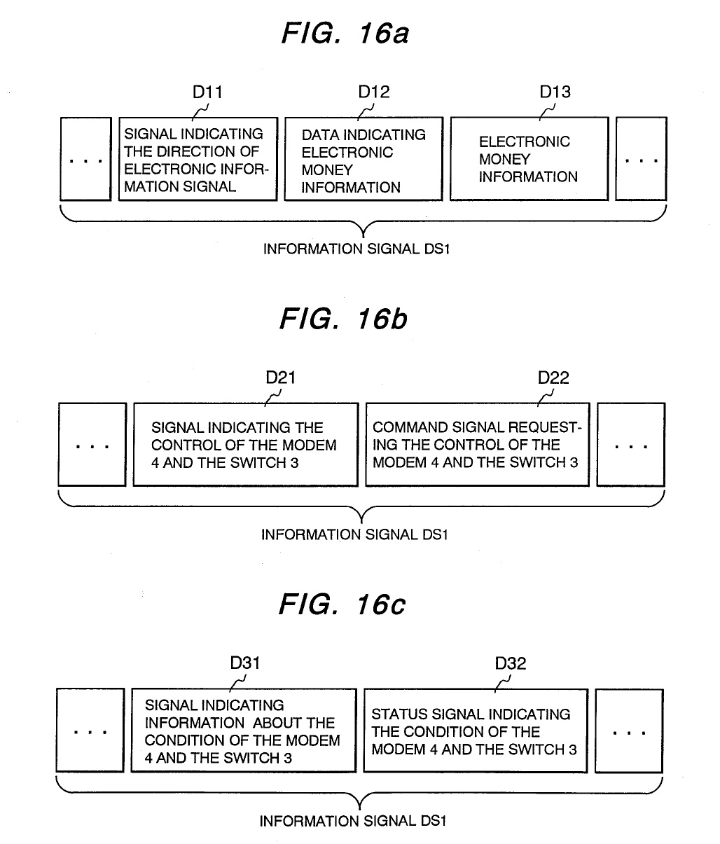

FIGS. 16(a), 16(b) and 16(c) show the contents of the light information signal L1 used as the information signal DS1.

The information signal DS1 shown in FIG. 16(a) is a signal indicating electronic money information on transfer. The information signal DS1 consists of a direction signal D11 indicating the direction of transfer of the information signal DS1, information D12 indicating that the information signal DS1 carries electronic money information, and electronic money information D13.

The information signal DS1 shown in FIG. 16(b) is a control signal S1 for controlling the MODEM 4 or a control signal S2 for controlling the switch 3. The information signal DS1 consists of information D21 indicating that the information signal DS1 carries a control signal for controlling the MODEM 4 or the switch 3, and a command signal D22 for controlling the switch 3 or the MODEM 4.

The information signal DS1 shown in FIG. 16(c) is an information signal indicating the status of the MODEM 4 and the switch 3. The information signal DS1 consists of information D31 indicating that the information signal DS1 carries information indicating the status of the MODEM 4 and the switch 3, and a status signal D32 indicating the status of the MODEM 4 or the switch 3.

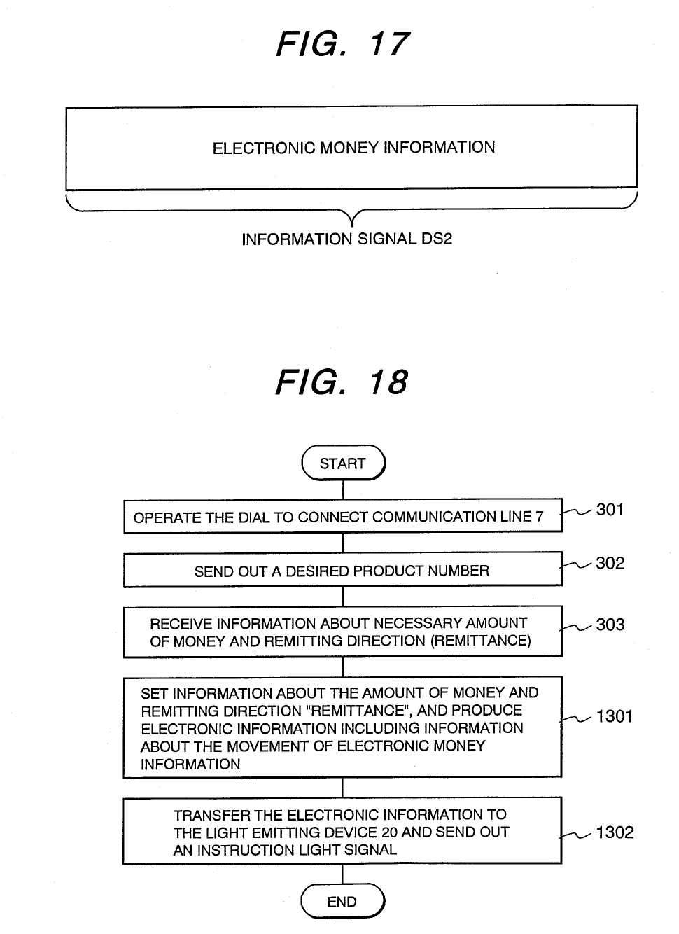

FIG. 17 shows the construction of the information signal DS2 indicating electronic money information written into or read from the IC card 1.

The information signal DS2 indicating electronic money information to be written into or read from the IC card 1 is encrypted and the encrypted information signal DS2 is stored in the IC card 1 to prevent the information signal DS2 stored in the IC card 1 from being altered dishonestly by ordinary means. The encrypted electronic money information is transferred for the substantial transfer of the electronic money information stored in the IC card 1. The electronic money information D13 included in the information signal DS1 shown in FIG. 16(a) is the direct use of the information signal DS2 indicating the electronic money information read from the IC card 1.

The operation of the seventh embodiment will be described below.

FIG. 18 is a flowchart of an information processing procedure to be carried out by the external information processor 8 shown in FIG. 15, in which steps corresponding to those of the information processing procedure shown in FIG. 13 are designated by the same step numbers.

The operation of the seventh embodiment will be described on an assumption that the seventh embodiment is applied to purchasing a product by mail-order. The operation of the external information processor 8 is similar to that of the external information processor 8 shown in FIG. 11 for carrying out the information processing procedure shown in FIG. 13. The light information signal L given by the light emitting device 20 to the light emitting/receiving unit 23 of the second terminal unit 2b has the structure shown in FIG. 12.

The control unit 6 of the terminal unit 2 monitors the output of the light emitting/receiving unit 23 continuously. When the light emitting/receiving unit 23 receives a light instruction signal L, the control signal S4 is given to the control unit 6 to instruct the control unit 6 to execute various control processes.

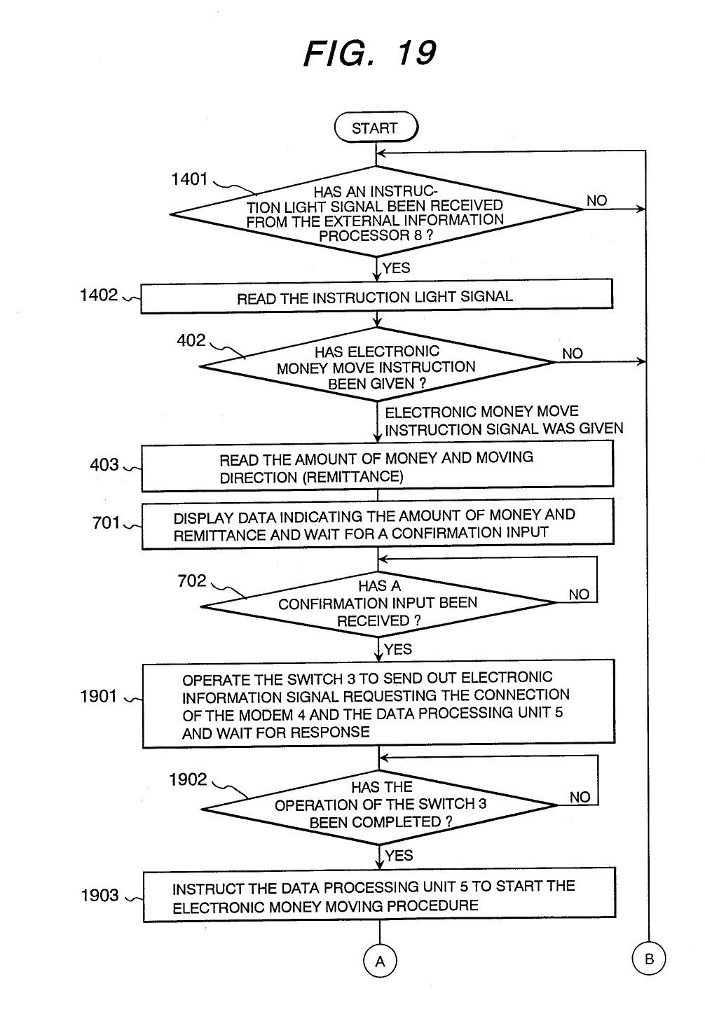

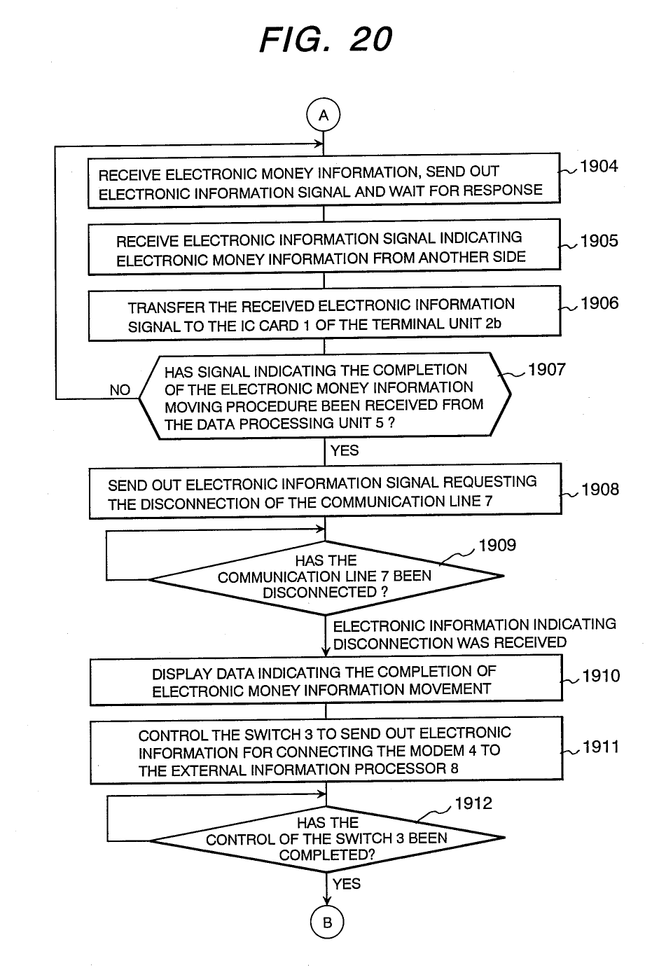

A procedure to be carried out by the control unit 6 is shown in flowcharts in FIGS. 19 and 20, in which steps corresponding to those of the information processing procedure shown in FIG. 14 are designated by the same step numbers and the description thereof will be omitted to avoid duplication.

Referring to FIG. 19, steps 1401 to 702 are the same as those of the procedure shown in FIG. 14 to be carried out by the control unit 6 of the terminal unit 2 shown in FIG. 11. The light emitting/receiving unit 23 receives the light instruction signal L from the external information processor 8, converts the light instruction signal L into a corresponding electric information signal of a structure as shown in FIG. 12, and gives the electric information signal to the control unit 6. If the control unit 6 detects the information D1 directing the transfer of electronic money information, the control unit 6 reads information D3 indicating an amount of money and information D2 indicating a transfer direction from the electronic money information, displays the information D2 and D3 on the display 13, and prompts the user to confirm the information D2 and D3. These operations are executed in steps 1401 through 701.

When the user confirms the information D2 and D3 by operating the input unit 12 (step 702), the control unit 6 sends an information signal DS1 of the structure as shown in FIG. 16(b) through the data processing unit 5 to the light emitting/receiving unit 23. The light emitting/receiving unit 23 provides a light information signal L1 indicating the information signal DS1. The light emitting/receiving unit 22 of the first terminal unit 2a receives the light information signal L1, converts the light information signal L1 into a corresponding electric information signal DS1, and gives the information signal DS1 to the MODEM information processing unit 21. The MODEM information processing unit 21 analyzes the information signal DS1. Since the information signal DS1 has the structure as shown in FIG. 16(b), the MODEM information processing unit 21 generates control signals S1 and S2 to control the MODEM 4 to connect to the communication line 7 for a while and to make the switch 3 select the MODEM information processing unit 21. Consequently, the MODEM 4 is connected to the data processing unit 5 (step 1901).

Upon the completion of the switching action of the switch 3, the modem information processing unit 21 generates an information signal DS1 of a structure as shown in FIG. 16(c) indicating the status of the MODEM 4 and the switch 3, and gives the same through the light emitting/receiving devices 22 and 23 and the data processing unit 5 to the control unit 6 to inform the control unit 6 of the completion of the switching operation of the switch 3 (step 1902). Then, the control unit 6 gives a control signal S3 directing the transfer of the electronic money information to the data processing unit 5 (step 1903).

Upon the reception of the control signal S3, the data processing unit 5 reads the electronic money information DS2 of a structure as shown in FIG. 17 from the IC card 1 under the control of the control unit 6, generates an information signal DS1 of a structure as shown in FIG. 16(a) by adding the information D12 identifying electronic money information and a signal D11 indicating an electronic money information transfer direction to the electronic money information DS2, and sends the information signal DS1 through the light emitting/receiving units 23 and 22 to the MODEM information processing unit 21 of the first terminal unit 2a. The signal D11 included in the information signal DS1 indicates whether the information signal DS1 is an outgoing signal or an incoming signal with respect to the control unit 6. The MODEM information processing unit 21 decides that the information signal DS1 is an outgoing signal including the electronic money information to be sent to the host apparatus 10 (FIG. 2) from the signal D11 and the information D12, and sends the information signal DS1 through the switch 3, the MODEM 4 and the communication line 7 to the host apparatus 10.

The electronic money information read out from the IC card 1 is thus sent to the host apparatus 10, while the control unit 6 remains in a standby state (steps 1904, 1907).

When an information signal DS1 of a structure as shown in FIG. 16(a) including electronic money information is received from the host apparatus 10, the MODEM information processing unit 21 examines the information signal DS1 in the foregoing manner and sends the same through the light emitting/receiving units 22 and 23 to the data processing unit 5 of the second terminal unit 2b. The control unit 6 decides that the received information signal DS1 indicates electronic money information from a signal D11 and information D12 extracted from the information signal DS1 by the data processing unit 5, and makes the data processing unit 5 receive the electronic money information D13 included in the information signal DS1 (step 1905) and makes the data processing unit 5 write electric money information DS2 of a structure as shown in FIG. 17 into the IC card 1 (step 1906).

Upon the completion of operations for sending out or receiving the information signal DS1 of a structure as shown in FIG. 16(a) including electronic money information, the data processing unit 5 gives an electronic money information transfer process completion signal to the control unit 6 (step 1907). Then, the control unit 6 gives the information signal DS1 of a structure as shown in FIG. 16(b) to the MODEM information processing unit 21 of the first terminal unit 2a to disconnect the first terminal unit 2a from the communication line 7 (step 1908). The MODEM information processing unit 21 generates a control signal S1 on the basis of the information signal DS1 to disconnect the MODEM 4 from the communication line 7, and sends an information signal DS1 of a structure as shown in FIG. 16(c) indicating the status of the MODEM 4 and the switch 3 in the foregoing manner to the control unit 6 of the second terminal unit 2b. The control unit 6 detects the disconnection of the MODEM 4 from the communication line 7 (step 1909) and makes the display 13 display a signal indicating the completion of the electronic money information transfer (step 1910).

Subsequently, the control unit 6 gives an information signal DS1 of a structure as shown in FIG. 16(b) for operating the switch 3 in the foregoing manner to the MODEM information processing unit 21 of the first terminal unit 2a (step 1911). The MODEM information processing unit 21 generates a control signal S2 to control the switch 3 so as to connect the external information processor 8 with the MODEM 4, generates an information signal DS1 of a structure as shown in FIG. 16(c) indicating the status of the switch 3 and the MODEM 4, and gives an information signal DS1 to the control unit 6 of the second terminal unit 2b. When the control unit 6 detects the completion of the operation for switching the switch 3 from the information signal DS1 (step 1912), processing procedure returns to step 1401 of FIG. 9 and waits until the next light instruction signal L is received.

Thus, in the seventh embodiment, the terminal unit 2 is able to exchange electronic money information indicating the amount of money and the transfer direction in a noncontact transfer mode. Therefore, the terminal unit 2 can be contained in separate cases capable of being handy and mobile.

In the seventh embodiment, the external information processor 8 carries out only operations for obtaining basic information including the amount of money and the remitting direction, the actual electronic money information is transferred after the user has entered a confirmation signal by operating the input unit 12. Thus, all the steps of the information processing procedure for transferring the electronic money information are executed by the control unit 6. Accordingly, the seventh embodiment is able to transfer the electronic money information more safely than the first embodiment.

Although the MODEM 4 and the external information processor 8 are separate components in the seventh embodiment, no problem arises even if the MODEM 4 and the external information processor 8 are incorporated together after securing the reliability of the MODEM 4. In such a case, the light emitting device 20 for emitting light instruction signal and the light emitting/receiving unit 22 may be substituted by a single device without any problem.

The seventh embodiment may employ the power circuit 14 shown in FIG. 8 or 10 for the same effect.

As is apparent from the foregoing description, according to the present invention, electronic money information can be transferred through a data communication means connected to a public data network by incorporating the communication means into a private terminal device possessed by a user. Accordingly, the user is able to use service by means of the IC card without using a special device for appreciating service.

According to the present invention, the device necessary for transferring electronic money information is able to operate independently from peripheral devices, such as other information processors not directly participating in transferring the electronic money information. The present invention enables the accomplishment of an electronic money information transfer procedure once the electronic money information transfer procedure has been started even if the peripheral devices malfunction. Thus, reliability of the terminal device itself can be secured, and the electronic money information transfer procedure can be carried out by using the private terminal device personally owned.

What is claimed is:

1. A method for transferring electronic money comprising the steps of:
receiving an instruction from an external device to transfer electronic money to/from an IC card, the external device being connected to a modem via a switch;
reading an amount of electronic money to be transferred and the direction in which the electronic money should be transferred;
displaying the amount of electronic money and the direction in which the electronic money should be transferred;
determining if a confirmation has been received in response to the step of displaying;
if a confirmation has been received, operating the switch to connect the modem to a data processing unit which processes electronic money transactions with the IC card, while disconnecting the modem from the external device;
instructing the data processing unit to transfer the electronic money to/from the IC card.

2. The method according to claim 1, further comprising the step of:
after completion of transferring of the electronic money to/from the IC card, operating the switch to connect the modem to the external device while disconnecting the modem from the data processing unit.

3. The method according to claim 1, further comprising the step of:
providing, from a power circuit having a storage battery, a supply voltage to the data processor, the communication circuit, the switching circuit and the control circuit during at least transferring of the electronic money to/from the IC card.

4. The method according to claim 3, further comprising the steps of:
receiving, by a power receiving circuit, power from an external power source; and
selecting one of said power receiving circuit and said power circuit;
wherein said power receiving circuit is selected to apply an output voltage of said power receiving circuit as a supply voltage in an ordinary state, and said power circuit is selected to apply an output voltage of said power circuit as the supply voltage when said output voltage of said power receiving circuit drops below a predetermined value.

5. The method according to claim 4, further comprising the steps of:
generating, by a light emitting device, light instruction signals; and
receiving, by a light receiving device, the light instruction signals;
wherein, upon receiving the light instruction signal, providing at least an electronic money information transaction start instruction to start the transfer of electronic money.
